(19) United States
(12) Patent Application Publication
(10) Pub. No.: US 2005/0187778 A1
(43) Pub. Date: Aug. 25, 2005

(54) Method and system for estimating the value of real estate

(76) Inventor: Guy Mitchell, Aurora, CO (US)

Correspondence Address: BAKER BOTTS L.L.P., 2001 ROSS AVENUE, 6TH FLOOR, DALLAS, TX, 75201, US

(21) Appl. No.: 10/784,001

(22) Filed: Feb. 20, 2004

(51) Int. Cl. G06F 17/60

(52) U.S. Cl. 705/1

(57) ABSTRACT

One aspect of the invention is a method for estimating a particular home's value. An equation is created using multiple linear regression techniques to calculate a plurality of coefficients each associated with one of a plurality of data types that is correlated with actual market prices of a plurality of homes. The plurality of homes may comprise a statistically significant number of homes. The equation is used to estimate the particular home's value.

### TECHNICAL FIELD OF THE INVENTION

This invention relates generally to real estate and more particularly to a method and system for estimating the value of real estate.

### BACKGROUND OF THE INVENTION

Residential real estate is appraised for various purposes. For example, when a homeowner desires to sell their home, the real estate agent often attempts to appraise the value of the home to set an initial selling price. Unfortunately, the methods currently used for such appraisals often produce inaccurate estimates.

Typically, a real estate agent or appraiser seeking to appraise the value of a home will look at past home sales in a neighborhood and use three to four “comparable” homes to make an estimate. Where sufficient data is not available for a particular neighborhood, the real estate agent may use several homes in adjacent neighborhoods. Most often, only a few houses (typically less than 10) are used to make an appraisal.

There are many problems with using only several comparable homes for creating an appraisal. First, the sample size is typically too small. Using less than 10 homes to make an appraisal estimate often produces results which statistically cannot be trusted. In addition, the houses that are compared often have significant differences. Houses of different sizes often do not have prices that vary in a linear relationship. Different models of houses may be more desirable than other models. Different houses may have different upgrades which significantly affect their value. Different lot sizes may affect value. The location of the house (e.g., corner lot, next to park, next to golf course, next to power lines) may have a significant effect on value. Also, the builder who built the house can affect value as some builders have better reputations than other builders. The neighborhood that a house is in may also affect value. Unfortunately, existing appraisal methods often either do not take any of this information into account or take it into account in a haphazard manner.

### SUMMARY OF THE INVENTION

One aspect of the invention is a method for estimating a particular home's value. An equation is created using multiple linear regression techniques to calculate a plurality of coefficients each associated with one of a plurality of data types that is correlated with actual market prices of a plurality of homes. The plurality of homes may comprise a statistically significant number of homes. The equation is used to estimate the particular home's value.

The invention has several important technical advantages. Various embodiments of the invention may have none, one, some or all of these advantages without departing from the scope of the invention. The invention allows the appraisal of a home to consider a larger number of samples such that a more accurate estimate of a home's value can be achieved. In addition to using larger sample sizes, embodiments of the invention may use more statistical data than is typically used to estimate the value of a home. Thus, calculations made using the invention may produce more accurate estimates of home value by taking into account the collective view of those buying and selling homes (or appraising, financing them, etc.) as to the importance of one or more factors to the price of homes.

### BRIEF DESCRIPTION OF THE DRAWINGS

For a more complete understanding of the present invention and the advantages thereof, reference is now made to the following descriptions taken in conjunction with the accompanying drawings in which:

FIG. 1 illustrates a block diagram of a general purpose computer that may be used in accordance with the present invention;

FIG. 2 illustrates an example architecture of a system that may be used to create appraisal estimate equations for use with the prevent invention; and

FIG. 3 illustrates a method of creating appraisal estimate equations for homes in accordance with the present invention.

### DETAILED DESCRIPTION OF THE DRAWINGS

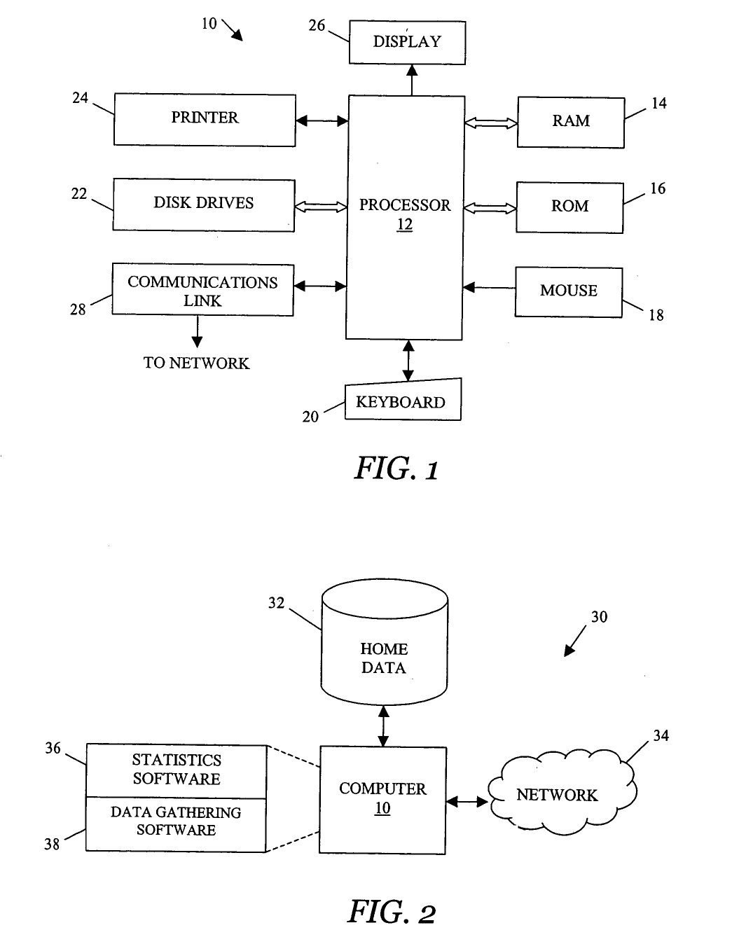

The preferred embodiment of the present invention and its advantages are best understood by referring to FIGS. 1-3 of the drawings, like numerals being used for like and corresponding parts of the various drawings.

FIG. 1 illustrates a general purpose computer 10 that may be used in connection with one or more of the pieces of software employed by the present invention. General purpose computer 10 may be adapted to execute any of the well-known OS2, UNIX, Mac-OS, Linux, and Windows Operating Systems or other operating systems. General purpose computer 10 comprises processor 12, random access memory (RAM) 14, read only memory (ROM) 16, mouse 18, keyboard 20 and input/output devices such as printer 24, disk drives 22, display 26 and communications link 28. The present invention may include programs that may be stored in RAM 14, ROM 16 or disk drives 22 and may be executed by processor 12. Communications link 28 may be connected to a computer network but could be connected to a telephone line, an antenna, a gateway, or any other type of communication link. Disk drives 22 may include a variety of types of storage media such as, for example, floppy disk drives, hard disk drives, CD ROM drives or magnetic tape drives. Although this embodiment employs a plurality of disk drives 22, a single disk drive 22 could be used without departing from the scope of the invention. FIG. 1 provides one example of a computer that may be used with the invention. The invention could be used with computers other than general purpose computers as well as general purpose computers without conventional operating systems.

The invention includes logic contained within a medium. In this example, the logic comprises computer software executable on a general purpose computer. The medium may include one or more storage devices associated with general purpose computer 10. The invention may be implemented with computer software, computer hardware, or a combination of software and hardware. The logic may also be embedded within any other medium without departing from the scope of the invention.

The invention may employ multiple general purpose computers 10 networked together in a computer network. Most commonly, multiple general purpose computers 10 may be networked through the Internet and/or in a client server network. The invention may also be used with a combination of separate computer networks each linked together by a private or public network.

FIG. 2 illustrates an architecture of a system 30 that may be used to create real estate appraisal estimates in accordance with the invention. System 30 comprises computer 10, network 34, home data database 32, statistics software 36 and data gathering software 38. Computer 10 may obtain relevant data for estimating home values and store the data in home data database 32. Computer 10 may obtain such data using network 34. Network 34 may be the Internet, another network connected to the Internet, a client server network with access to the relevant data, and/or any other type of network. Alternatively, the relevant data may be obtained using portable storage media such as a floppy disk, CD ROM, portable hard drive, DVD-ROM, or any other type of portable storage media. Where portable storage media are used, the data may be transferred to database 32 and/or used directly by computer 10 while still resident on portable storage media in accordance with the remainder of the invention. Also, where data is retrieved using network 34, the data may be stored in database 32 and/or accessed directly by computer 10 during the regression as discussed below.

System 30 further includes computer software executable on computer 10. As noted above, one or more computers 10 may be used without departing from the scope of the invention. In this embodiment, system 30 may include data gathering software 38. Data gathering software 38 may be omitted without departing from the scope of the invention. For example, data gathering software 38 may be omitted if the data for database 32 is obtained from portable storage media. Where data gathering software 38 is used, data gathering software may comprise, for example, a web browser. Alternatively, data gathering software 38 may comprise a dedicated piece of software used to gather the particular statistics and other data stored in database 32. Data gathering software may be used to retrieve the relevant data from one or more computers networked to computer 10 through network 34. In this embodiment, data gathering software 38 may be used, for example, to obtain economic data published by the government, ratings of home builders produced by various rating organizations, appraisal data and statistics about a particular home available from government and/or other taxing agencies, etc.

Statistics software 36 may be used to perform a multi-variate regression analysis (such as a multiple linear regression), on various data stored in database 32. While this embodiment may employ multiple linear regression techniques, other multi-variate regression techniques may be performed without departing from the scope of the invention. Generally, other multi-variate regression techniques may use more than one independent variable. While the examples below use actual values of independent variables, functions of the independent variables could also be used without departing from the scope of the invention. For example, the logarithm, cosine, sine, and/or tangent of a particular value could be used. In addition, a particular value could be an ordinal or a categorical value converted to a cardinal value.

In operation, the system illustrated in FIG. 2 can be used in various ways to provide appraisals to those desiring an appraisal. For example, a web application can be used to allow users to obtain an appraisal through the Internet over computer network 34. In such an example, a user may use a web application that interacts with a server application on computer 10 to provide data concerning the home for which an appraisal is desired. Computer 10 may then use the regression techniques described below to produce an equation to estimate the value of the home in question. This equation would then be applied to the data supplied by the user through network 34 to produce an appraisal estimate. The appraisal estimate along with explanatory data may then be provided back through network 34 to the user who requested the appraisal.

Alternatively, system 30 could be used to gather data by a service organization who might then distribute statistics software 36 and/or home data database 32 to end users for use in standalone systems. The same type of distribution could also be used to end-users for use on the end-user's computer networks. Home data database 32 could be updated on a weekly, bi-monthly, monthly, and/or quarterly basis or on any other basis depending upon the desires of the service provider. Statistics software 36 and/or home data database 32 could be updated through downloads through a network 34 by end-users or by sending the updates on a computer readable storage medium to the end-users directly.

The invention herein may be applicable to the appraisal of many different types of real estate. The invention may preferably be used to provide an appraisal estimate for home values. As used herein, the term “home” is meant to refer broadly to any type of dwelling where humans ordinarily live. For example, the term “home”, is meant to include single-family homes, townhouses, apartments, duplexes, house boats, and/or condominiums. In the case of apartments, duplexes, etc., the techniques of the invention may be used to appraise the value of the real estate, and/or the rental value of the real estate. Thus, in the case of an apartment building, the invention could be used to estimate the market value of the entire apartment building and/or estimate the monthly rent for a particular apartment within the building.

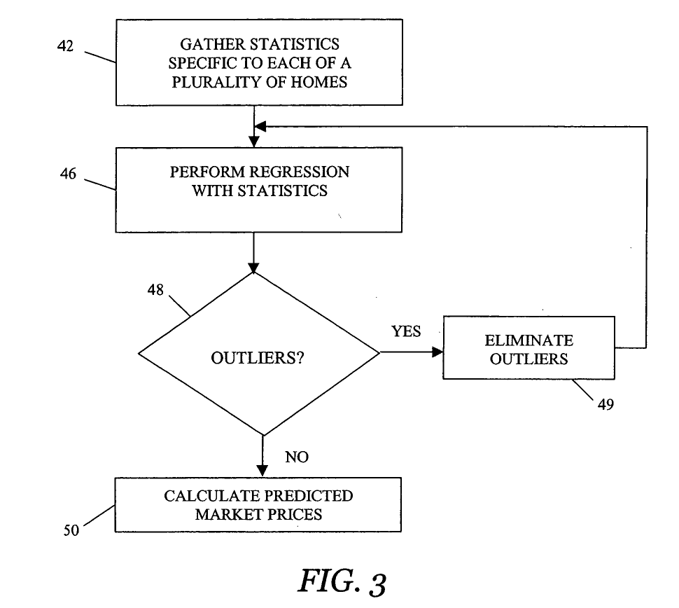

FIG. 3 illustrates a method for appraising real estate in accordance with the present invention. In step 42, a plurality of statistics specific to each of a plurality of homes is gathered. The statistics gathered in step 42 may include, for example, macro statistics about the local, state, and/or national economy. The statistics gathered may also include statistics about the home builder who built the home in question. These statistics may be continuously gathered as homes are sold and as new economic statistics are reported. The statistics may also be gathered as statistics available from various government agencies such as taxing agencies that appraise the value of homes change. Statistics may also be gathered from on-site appraisals of homes.

Various data in the database 32 may be kept historically. For example, because economic conditions can affect the price of a home, various economic data may be maintained over time such that the equations of the present invention, may, in some instances take into account the economic conditions for particular home sale data used in the appraisal estimate. To illustrate more specifically, if a house that was sold in the same neighborhood is being used as part of the data for the appraisal estimate and that house was sold two years ago, then the economic conditions of two years ago may be used in some instances to improve the accuracy of the estimate of that home's value.

In the case of other data which changes over time, the value of the data at multiple points in time may be taken into account in the appraisal estimate. For example, in the case of a builder index that provides some measure of the quality of particular builders, the appraisal estimate may take into account the value of the builder index at various points in time.

Note that data used in the regression may be retrieved from database 32 or obtained from a storage media or through network 34 at the time the regression and/or correlation is performed. Any combination of the foregoing may also be used. Any data source may be used to obtain relevant data.

As noted above, one of the types of statistics that may be used in the appraisal process of the present invention is economic statistics. Economic statistics may include, for example, various macro economic data and/or an economic index based upon a plurality of other economic statistics. In one embodiment, one or more of the following statistics may be used for appraisal estimates: the consumer price index, unemployment rate, the prime interest rate, the Dow Jones Industrial Average, the NASDAQ, average mortgage rates (such as for 15-year and 30-year fixed interest rate loans), the consumer confidence rating, the rate of inflation, the rate of productivity, the rate of growth, estimates of business spending such as durable goods orders, the growth rate in gross national product, the value of the dollar versus other currencies, consumer spending, consumer debt, and any other economic statistic that may be correlated to home prices.

With respect to builder indices, the invention may use builder indices available from various organizations, and/or a builder index calculated using the data in database 32. Organizations such as JD Power & Associates currently publish builder indices for various major metropolitan areas. Such indices may be aggregated on a national level, and/or used individually for the geographic area where a house is located. If no builder index is available for the particular geographic area where a house is located, then the best available data from a nearby area may be used. Alternatively, data in database 32 may be used to create an estimate on the value added to or subtracted from a home's value by the fact that a particular builder built a home. The regression techniques used below to estimate home value may also be used to determine a builder index. In some embodiments, builder indices with ratings for each builder may be available from multiple outside organizations. Multiple builder ratings may be used in the appraisal estimate without departing from the scope of the invention. A builder index could simply include ordinal rankings or another numerical measure such as, for example, a number of “stars.”

With respect to individual houses, numerous pieces of data can be gathered. It is contemplated that certain data that is available for certain homes may not be available for other homes. Where data is not available for a home, in some cases an estimate may be made based upon data from other homes near that home. Also, an estimate can sometimes be made using prior data for the home that has become outdated (e.g. using a 5-year-old tax appraisal when no new appraisal is available). In other cases, where certain data values are missing and the corresponding statistic type is highly correlated with market price, that home may be excluded as a data point when calculating appraised value. The statistic might also be excluded from the calculation in some instances.

Statistic types for particular homes may include one or more of the following values as well as other values not listed: past sale price, past sale price per square foot, past sale price per lot size square footage, square footage, lot size, appraised value, appraised value per square foot, appraised value per lot size square footage, year of construction, age of house, builder, zip code, GPS coordinates, the presence or absence of various types of upgrades, appraisal estimates of various types of upgrades, a neighborhood index computed based on appraisal data or produced by an outside organization, a neighborhood identification, various statistical ratings of the city, county, and state in which the home is located, property tax rates, school district identification, school district ratings, the distance to expressways, the month and year in which a prior sale occurred, the total value of homes for sale in a geographic area at the time a prior sale of the home occurred, the total dollar value of sales in a particular geographic area at the time a prior sale occurred, the number of homes for sale at the time a particular sale occurred, the current total value of homes for sale in a particular geographic area, the current total dollar value of sales for a particular time period in a particular geographic area, the current number of homes for sale in a particular geographic area, and any other statistic type related to a particular home that may have a value effect. In the case of home improvements and/or upgrades, the data maintained may indicate that a particular upgrade is present or not present may include an estimate of the value of the upgrade, or both. Example home improvements that may be included are improved basements, kitchen upgrades, bathroom upgrades, garage size, landscaping, swimming pool, etc. In addition to the statistic types listed above, statistic types reflecting a home's proximity to other desirable and/or undesirable locations may be included. For example, proximity to schools, parks, golf courses, industrial areas, landfills, dumps, fire stations, police stations, retail establishments, restaurants, athletic facilities, etc., may affect home value. All statistics of the statistic types described herein may be kept in database 32, obtained through network 34, obtained from portable storage media, or omitted without departing from the scope of the invention.

Any of the statistic types discussed in this patent may be omitted without departing from the scope of the invention. Other statistic types may be included without departing from the scope of the invention.

In addition to the data stored in database 32, other data may be calculated at the time of the appraisal. For example, one of the factors that may affect the accuracy of an appraisal is the proximity of the home being appraised to the homes being used for the appraisal estimate. Thus, at the time of the appraisal, a distance from the home being appraised to each of the sample homes being used in the calculation may be used as one of the statistics used in the regression analysis.

It is preferable that the invention be used with a statistically significant sample size in order to increase the accuracy of the estimate. Thus, while the invention will almost certainly not use every home in the database to estimate the value of one particular home, a statistically significant number of sample homes should be chosen to increase the accuracy of the results. In one embodiment, 30 or more homes may be used to increase the accuracy of the estimate. However, any number of homes sufficient to provide statistically accurate results with an acceptable error rate may be used without departing from the scope of the invention. Where a sample size that is not statistically significant is chosen, the results may be unreliable.

The invention may increase the accuracy of estimates of the value of homes in new subdivisions. Often, little or no data is available for comparable homes in new subdivisions. However, because the invention may take into account ratings of builders and ratings of nearby neighborhoods as well as economic data, more reasonable estimates may be available than with existing techniques.

Note that for each of the above statistic types, in addition to the statistic types included, various statistical ratings or functions of the above statistic types may be used during the appraisal process. For example, while an indication of the school district in which a house is located may be used, statistical ratings of school districts may also be used in the appraisal process.

In some embodiments, before performing the regression analysis in step 46, a correlation analysis may be performed to determine the degree of correlation between various statistic types stored in database 32 and the market price of the homes being analyzed. In addition to determining correlation between various statistics and market price, the correlation between the various statistic types may also be determined. This type of correlation may be performed using computer software commonly available to those in the art for use in performing correlation measurements for a set of data values.

A correlation analysis may produce a set of correlation values which indicate the correlation among many different variables. The correlation analysis may identify those statistic types likely to be most useful for the regression analysis. A correlation threshold can be chosen below which certain statistic types are discarded for use in a regression analysis and above which the statistic types are included.

In addition to eliminating statistic types with low correlation against the data to be used as the dependent variables in the regression analysis, other statistic types may also be discarded. A desirable outcome of the regression analysis may be, for example, a solution that requires the fewest amount of variables to create a solution with a high F-ratio. Certain data values that are likely to be cross-correlated with one another and have similar predictive value for market price may be eliminated.

As noted above, the correlation step is optional and may be omitted. The invention may use step-wise linear regression. This type of regression can eliminate statistic types with low significance in relation to the dependent variable or with high significance but high co-linearity with other statistic types included in the regression.

In step 46, a regression analysis is performed with various statistics from database 32. This embodiment uses a multiple linear regression analysis but any suitable type of regression may be used. Typically, the market price of the home will be used as the dependent variable with one or more of the statistic types discussed above as independent variables. While market price may be used as a dependent variable, other measures predictive of market value may be used such as price per square foot. Note that steps 46-49 can be repeatedly performed for multiple dependent variables. In other words, steps 46-49 could be performed using market price and/or price per square foot as dependent variables.

In this embodiment, a step-wise linear regression is used. If correlation was not performed, then after the multiple linear regression has been performed in step 46, the significance of each of the various statistic types used in the regression may be examined. Any statistic type with a confidence value over a particular threshold may be disregarded. Any threshold may be selected without departing from the scope of the invention.

Depending upon the particular home at issue, the present invention may produce results such that the statistic types that are significant and should be included in the equation to calculate an estimate of market value of a home during one time period and for one particular home are not significant and are disregarded during a different time period or for a different home. This variance may reflect the changing emphasis on various statistics as reflective of market value by those purchasing homes. Thus, the particular statistic types useful for estimating market value of a home may vary for each time period by geographic area, and even for particular homes.

In step 48 it is determined whether any outliers exist. If so, then the outliers may be eliminated in step 49. If not, then the method proceeds to step 50. Steps 48 and 49 may be eliminated without departing from the scope of the invention.

In step 49 outliers may be eliminated. An outlier may be a home whose predicted market price based upon the linear regression has a variance with its actual market price and/or appraised value by more than a threshold amount. While any threshold can be chosen, in this embodiment, a variance by more than a particular number of standard deviations may be used as a threshold. While step 49 may be omitted in some embodiments, it is believed that the predictive accuracy of the regression model may be improved by eliminating outliers. Any numerical criteria could be used to eliminate outliers without departing from the scope of the invention. By returning to step 46 after outliers have been eliminated, the overall accuracy of the equation determined by the regression analysis can be improved. However, a single regression could be used without departing from the scope of the invention.

In a subsequent pass through step 46, regression is performed with the outliers eliminated but using the statistic types that were used the first time regression was performed. Alternatively, the subsequent regression performed could use a subset of the statistic types such as those statistic types that were not eliminated by the first regression analysis due to co-linearity and/or significance issues. While a step-wise linear regression can be used in subsequent passes, other types of multiple linear regression could also be used. Also, certain statistic types could be forced to be included or not included in the regression analysis.

When the final regression has been performed, the regression produces a set of coefficients (and a constant which may be zero) associated with each significant statistic type that may be used to create a linear equation that is predictive of the dependent variable used during the regression. In this linear equation, the coefficient associated with a particular statistic type would be multiplied by the numerical value of the particular statistic having that statistic type for the particular home being appraised. The products of the coefficients and statistics would then be summed (some values could be negative) to obtain an estimate of the valuation of a particular home.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, Applicant wishes to note that he does not intend any of the appended claims to invoke paragraph 6 of 36 U.S.C. § 112 as it exists on the date of filing hereof unless “means for” or “step for” are used in the particular claim.

1. A method for estimating a particular home's value comprising:
creating an equation using multiple linear regression techniques to calculate a plurality of coefficients each associated with one of a plurality of data types that is correlated with actual market prices of a plurality of homes, wherein the plurality of homes comprises a statistically significant number of homes;
using the equation to estimate the particular home's value.

2. The method of claim 1:
wherein creating an equation further involves iteratively performing linear regression wherein outliers are eliminated from use in creating the equation after at least one iteration;
wherein outliers comprise homes whose actual selling price or appraised value varies by more than a threshold multiple of standard deviations from the home's estimated value as determined by the most recent iteration of the regression.

3. The method of claim 1:
wherein the plurality of data types includes a builder identification.

4. The method of claim 3:
wherein the plurality of data types includes a builder rating.

5. The method of claim 1:
wherein the plurality of data types includes a distance from the particular home.

6. The method of claim 1:
wherein the plurality of data types includes a statistical rating of a geographic area in which a home in the plurality of homes is located.

7. The method of claim 1:
wherein the plurality of data types includes an identification of at least one type of home upgrade.

8. The method of claim 4:
wherein the plurality of data types includes an identification of at least one type of home upgrade.

9. The method of claim 1:
wherein each of the plurality of homes comprises a dwelling type selected from the group comprising: single-family house, townhouse, apartment, duplex, houseboat, and condominium.

10. A method for estimating a particular home's value comprising:
creating an equation using multiple linear regression techniques to calculate a plurality of coefficients each associated with one of a plurality of data types that is correlated with actual market prices of a plurality of homes, wherein the plurality of data types includes a builder identification;
using the equation to estimate the particular home's value.

11. The method of claim 10:
wherein creating an equation further involves iteratively performing linear regression wherein outliers are eliminated from use in creating the equation after at least one iteration;
wherein outliers comprise homes whose actual selling price or appraised value varies by more than a threshold multiple of standard deviations from the home's estimated value as determined by the most recent iteration of the regression.

12. The method of claim 10:
wherein the plurality of data types includes a builder rating.

13. The method of claim 10:
wherein the plurality of data types includes a distance from the particular home.

14. The method of claim 10:
wherein the plurality of data types includes a statistical rating of a geographic area in which a home in the plurality of homes is located.

15. The method of claim 10:
wherein the plurality of data types includes an identification of at least one type of home upgrade.

16. The method of claim 12:
wherein the plurality of data types includes an identification of at least one type of home upgrade.

17. The method of claim 10:
wherein each of the plurality of homes comprises a dwelling type selected from the group comprising: single-family house, townhouse, apartment, duplex, houseboat, and condominium.

18. A system for estimating a particular home's value comprising:
a computer readable storage medium;
computer software stored on the storage medium and operable to:
create an equation using multiple linear regression techniques to calculate a plurality of coefficients each associated with one of a plurality of data types that is correlated with actual market prices of a plurality of homes, wherein the plurality of homes comprises a statistically significant number of homes, and
use the equation to estimate the particular home's value.

19. The system of claim 18:
wherein creating an equation further involves iteratively performing linear regression wherein outliers are eliminated from use in creating the equation after at least one iteration;
wherein outliers comprise homes whose actual selling price or appraised value varies by more than a threshold multiple of standard deviations from the home's estimated value as determined by the most recent iteration of the regression.

20. The system of claim 18:
wherein the plurality of data types includes a builder identification.

21. The system of claim 20:
wherein the plurality of data types includes a builder rating.

22. The system of claim 18:
wherein the plurality of data types includes a distance from the particular home.

23. The system of claim 18:
wherein the plurality of data types includes a statistical rating of a geographic area in which a home in the plurality of homes is located.

24. The system of claim 18:
wherein the plurality of data types includes an identification of at least one type of home upgrade.
